(19) United States
(12) Patent Application Publication
(10) Pub. No.: US 2011/0303176 A1
(43) Pub. Date: Dec. 15, 2011

(54) HCDS-ICwf-single Single Stage Hydrogen Compression & Delivery System for Internal Combustion Engines Utilizing Working Fluid

(76) Inventor: Ryan Reid Hopkins, Reno, NV (US)

(21) Appl. No.: 12/797,306

(22) Filed: Jun. 9, 2010

(51) Int. Cl. F02B 43/10; G05D 7/00; F17C 11/00

(52) U.S. Cl. 123/1 A; 206/7; 222/3

(57) ABSTRACT

The single stage hydrogen compression and delivery system for internal combustion engines utilizing a working fluid (HCDS-IC_{WF-Single}) consists of a thermally driven single compression stage metal hydride hydrogen compressor in line with high pressure hydrogen storage tanks and a pressure regulating hydrogen delivery system that supplies a controlled release of hydrogen to the internal combustion engine. The working fluid carries the thermal energy needed to the metal hydride compression stages to drive the hydrogen compression processes. The compressor is intended to be inseparable from the storage tank to ensure safe operation.

### FIELD OF THE INVENTION

The invention consists of a thermally driven hydrogen compressor, hydrogen storage reservoir, and a mixing chamber which are used to supply an engine with either pure or supplemental hydrogen for the combustion processes. The device utilizes a controlled release of the compressed hydrogen such that the ideal amount of hydrogen is being supplied to the engine at all times. The invention may also be used as a way to capture and use waste heat.

### BACKGROUND OF INVENTION

Hydrogen has long been known as a clean energy source and has the potential of being 100% renewable. Hydrogen's low energy density provides challenges in its being successfully integrated into industrial, commercial, and consumer energy production/applications. The application of metal hydride hydrogen compression for the uses of supplying hydrogen to combustion engines is proposed with this invention to make it a feasible and possible replacement or supplemental energy source while reducing the pollutants that are produced by engines consuming fossil fuels.

### SUMMARY OF INVENTION

The HCDS-IC (hydrogen compression and delivery system for internal combustion engines) composes of a thermally driven metal hydride hydrogen compressor, hydrogen storage medium, and a mixing/delivery chamber that is intended to be installed and used in conjunction with any or all internal combustion engines. The HCDS-IC may be used with a permanent hydrogen supply system that is also installed on the unit or with an external hydrogen supply.

The HCDS-IC may be used for both/either hydrogen supplementation in a fuel burning engine and/or hydrogen storage for a pure hydrogen burning engine. The design eliminates the transfer of high pressure hydrogen from off board the unit to on board the unit. The on board hydrogen compressor and storage allows the hydrogen supply to be at lower initial pressures and reduces the inconveniences and safety issues associated with high pressure gas transportation and delivery.

The integration of the hydrogen compression, storage, and delivery as proposed within this invention will allow more commercial, industrial, and consumer applications of hydrogen use that will reduce the reliance on fossil fuels. The mixing chamber design also simplifies the delivery of the system using simple thermodynamic and gas laws to govern the amounts of gas injected into the engine for optimal combustion conditions. Hydrogen is known for its ability to enable fossil fuels to burn faster and more completely, which in turn reduces the emissions from the fuel burning engines and increases the efficiencies of the engines. The application of this invention on the standard fuel burning engine is intended to increase the fuel efficiency while simultaneously reducing the emissions from the burn.

Pure hydrogen engines may also be used more readily if the hydrogen is compressed to higher pressures which increase the energy density of hydrogen. The HCDS-IC utilizes thermal, electrical, or both energy types to drive the compression of the hydrogen on board the unit. The effective compression of the hydrogen enables the high pressures needed to store sufficient amounts of hydrogen to run internal combustion engines to be attained, and the storage units allow the delivery of the compressed and stored hydrogen to be readily supplied to the engine as it is needed without any significant time lags.

### DETAILED DESCRIPTION OF INVENTION

The HCDS-IC_{S-WF-WH} consists of a hydrogen supply which may be a hydrogen production unit or a hydrogen storage reservoir (claim 7), the supplied hydrogen is then connected to a single stage metal hydride compressor which undergoes thermal cooling and heating cycles that drive the hydrogen compression (claims 1 and 2) and then the hydrogen is supplied to the engine via the delivery system. The thermal cycles utilize a heated or cooled working fluid to either extract or supply energy to the metal hydride reactors during the hydrogen absorption and desorption processes. The cooling cycles utilize a cool working fluid and forced convection over the metal hydride reactors to extract the excess thermal energy that is being produced by the hydrogen absorption process (claim 6). After the hydrogen is absorbed the supply line is temporarily closed using a valve and a heating cycle is initiated which supplies the thermal energy (via a hot working fluid) needed to cause the desorption of hydrogen out of the metal hydrides (claim 6). Since metal hydrides have the ability to store hydrogen at densities greater than liquid hydrogen, the hydrogen will be released at pressures which exceed the supply pressures upon completion of the thermal heating.

The compression system will use single stage metal hydride compression to compress the hydrogen (claim 2). Single stage compression consists of a reactor or groups of reactors arranged such that they absorb hydrogen from the same supply source and upon completion of the compression cycle, the hydrogen is delivered to the same destination. Thus upon desorption the hydrogen is supplied to the storage reservoir or directly to the engine for combustion. The metal hydride compression system may use multiple hydrogen reactors within each compression stage (claim 9). Thus implying that the multiple reactors within the same compression stage would be arranged such that they absorb hydrogen from the same source and supply the hydrogen to the same destination upon desorption, (the configuration of multiple reactors within the same compression stage is somewhat similar to the configuration of resistors in parallel within an electrical circuit). Upon completion of the first thermal compression cycle, compression cycles may be repeated to ensure that the hydrogen is being supplied within the systems desired parameters.

The metal hydride reactors may utilize a large variety of geometric configurations, and manufacturing processes. The metal hydride reactors may utilize metal hydride pellets which may be produced from metal hydride powders which were compressed under high pressures, sintered, or compacted using other means and may utilize any geometric configuration that is convenient or needed for the desired system, or the metal hydrides may remain in a non pellet form and the reactors may or may not utilize filters that prevent the metal hydride powders from exiting the reactor.

The compression and storage units are intended to remain connected at all times to eliminate any safety issues stemming from the handling of high pressure gases (claim 11). The hydrogen being supplied to the compressor from the hydrogen supply would be pressure regulated to ensure that it is at safe pressures for the initial hook up and the final detachment (if necessary), and the hydrogen coming out of the storage tank on board the unit would also be pressure regulated to supply the hydrogen to the engine under safe operating pressures. The compressor in line with the storage tank removes all unnecessary connections of high pressure gases that may prove unsafe to the user of the invention.

The compression and storage system may or may not be connected to the hydrogen source during operation (claim 12). If the hydrogen source is designed to be on board the consumption unit, then the compression and storage units will remain connected to the hydrogen source. If, however, the hydrogen source is solely used to charge the hydrogen reservoir of the system and is removed during consumption unit operation, then the compressor and the storage unit will not be in line with the hydrogen supply system during unit operation.

Upon completion of the compression, the hydrogen may be delivered to the IC engine directly or temporarily stored in a pressurized storage tank until needed (claims 15-20). The delivery of hydrogen to the IC engine utilizes a pressure regulating valve and a mixing chamber. If the system utilizes direct injection, the hydrogen will be released directly into the piston combustion chamber for mixing and combustion via its own pressure regulated line which would also utilize a pulsing valve such that hydrogen is only injected into the combustion chamber when needed.

The gas pressures will be regulated such that when the combustion chamber valve opens for the hydrogen and oxygen/air gases to flow and fill the combustion chamber, the amount allowed into the final combustion chamber will be approximately or at stoichiometric conditions or at the desired A/F (air to fuel) ratios (claim 17). The invention will obtain this condition by utilizing simple principles of thermodynamics and gas laws for the sizing of the mixing chamber in reference to the final combustion volume. The mixing chamber is sized to allow regulated flows of hydrogen and oxygen/air into the mixing chamber during the exhaust stroke of the piston within the engine. The chamber will be sized according to the size of the final volume within the combustion chamber upon which the combustible gases flow into the combustion chamber of the engine. In cases where the hydrogen is directly injected into the engine, the final combustion chamber or piston chamber will be utilized as the mixing chamber (claim 18).

### LIST OF DRAWINGS

FIG. 1: Single stage HCDS-IC utilizing working fluids.

FIG. 2: Isometric view of single stage compressor utilizing a working fluid bath in conjunction with high pressure storage tank.

FIG. 3: Top view of single stage compressor utilizing a working fluid bath in conjunction with high pressure storage tank.

FIG. 4: Multiple reactor tubes within working fluid bath of a single stage compressor (front view).

FIG. 5: Isometric view of possible multi reactor single compression stage reactor configuration.

FIG. 6: Possible configuration for metal hydride reactor tube.

FIG. 7: Cross section of reactor tube showing the enclosed metal hydride pellets.

### DESCRIPTION OF DRAWINGS

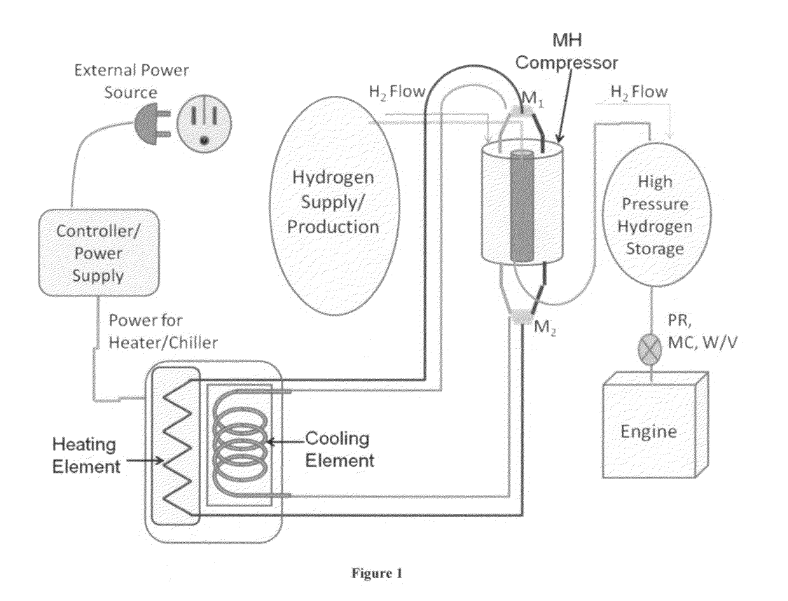

FIG. 1 shows a single stage metal hydride compressor HCDS-IC which utilizes a working fluid to supply the energy needed for hydrogen desorption and the energy sink for the hydrogen absorption. The compressed hydrogen goes into the storage reservoir and is supplied to the engine via a pressure regulated mixing chamber with a controlled valve (depicted in the figure by the label PR, MC, W/V). In the figure M₁ and M₂ depict working fluid manifolds that direct the hot or cold working fluids to the reactor as needed. The manifolds may also be replaced by a series of controlled valves.

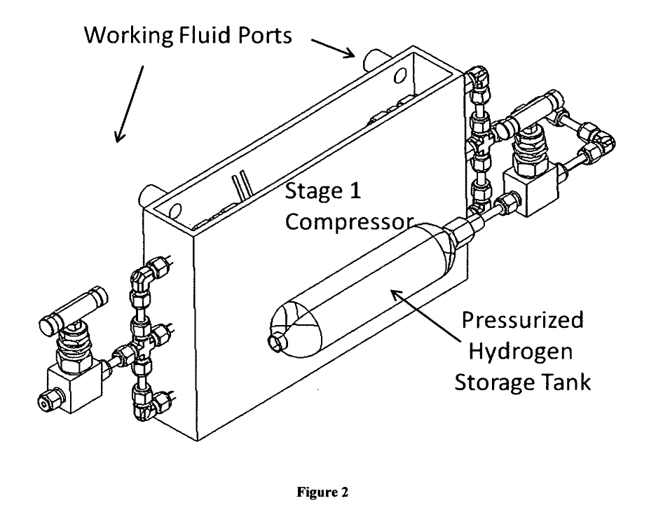

FIG. 2 displays an isometric view of a possible configuration for a single stage metal hydride compressor utilizing a working fluid bath in conjunction with a high pressure storage tank.

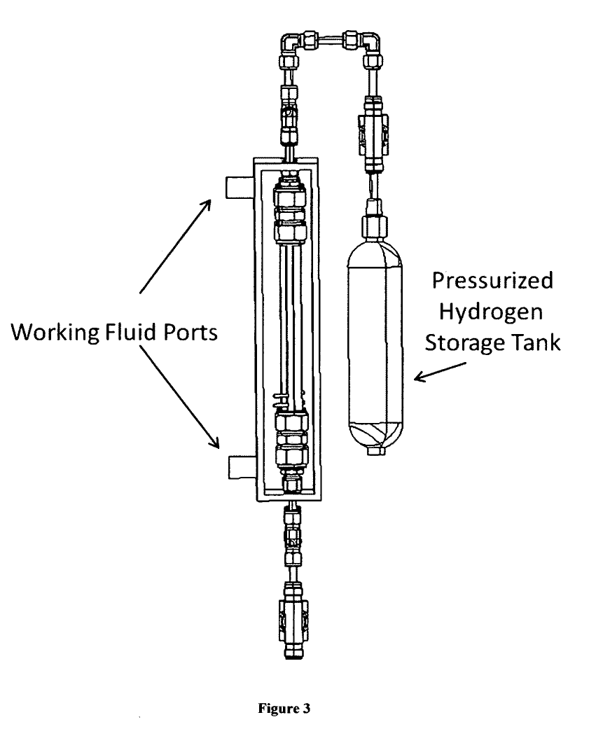

FIG. 3 illustrates the top view of a single stage compressor utilizing a working fluid bath in conjunction with high pressure storage tank. Within this figure the metal hydride reactor tubes are visible within the bath.

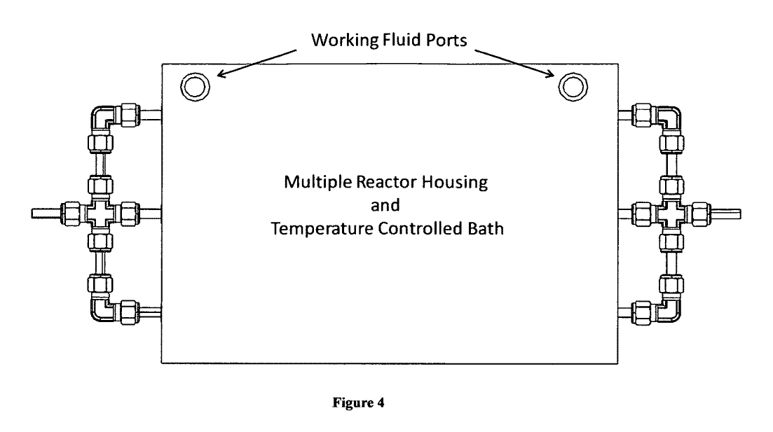

FIG. 4 depicts one of the possible designs that can be used for the working fluid bath housing multiple reactors. The bath housing allows the working fluids to enter the housing via the fluid ports and the fluids are then used to heat and cool the reactor tubes (which contain the metal hydride pellets).

FIG. 5 displays three reactor tubes which are configured to absorb and supply the hydrogen from the same source and then to the same destination. The invention does not put limits on the number of reactors that are used within the compression stage, thus multiple reactors may be added as needed.

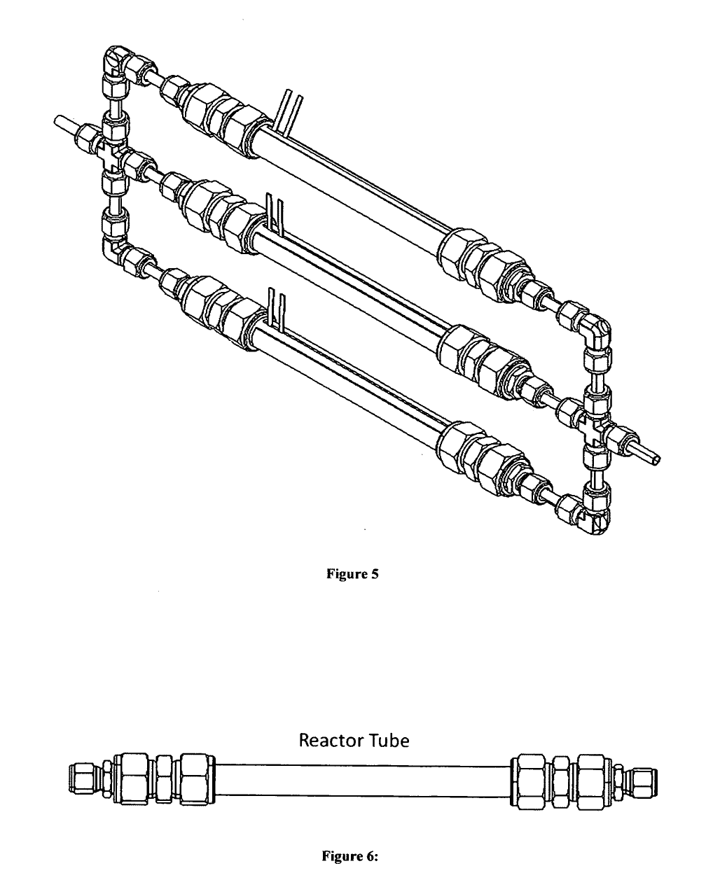

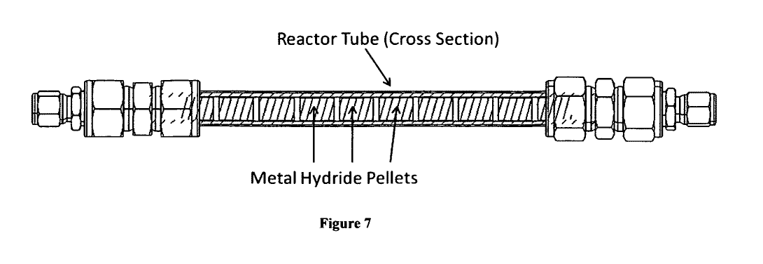

FIG. 6 illustrates one possible reactor tube configuration. The reactor tube houses the metal hydride pellets which are used for the hydrogen compression.

FIG. 7 displays the cross sectional view of the reactor tube showing the metal hydride pellets within the tube. The figure shows ten metal hydride pellets within the reactor, but the number may be increased or decreased according to the design parameters of the overall system. The invention does not put a limit on the amount of metal hydride within a reactor.

The schematics/drawings described within this section are for illustrative purposes, and the dimensions associated with the schematics/drawings are not actual dimensions. The geometries shown in the figures are not all inclusive, and any derivation of the system containing the same system components with different geometries are intended to fall under the description of the invention as set forth in the claims. It must also be noted that in many of the drawings the valves depicted are manual valves and these are to illustrate where valves could be placed. The valves may be manual or automated (solenoid valves, etc.) and are depicted in the drawings for illustrative purposes. It is also important to note that the reactor assemblies shown within all of the drawings use compression fittings, but this is not intended to limit the reactor construction to the use of compression fittings; indeed, the reactors may use welded fittings or the assemblies may utilize parts manufactured specifically for the geometries and uses of the final system that the invention is intended for.

1. The utilization of metal hydride alloys that have hydrogen absorption and desorption characteristics to drive the compression of hydrogen using a thermally controlled system.

2. The system uses single stage metal hydride compression.

3. The compression system may or may not use a storage medium for the hydrogen after its compression, depending on system requirements.

4. The storage medium as stated in claim 3, may include high pressure storage tanks and other metal hydride storage configurations.

5. The metal hydrides used may be composed of, but not limited to, the AB, AB₂, and AB₅ metal hydride types (an example of an AB₅ metal hydride is LaNi₅).

6. The thermal system in claim 1 may compose of a heating system utilizing a working fluid that either uses waste thermal energy from other sources or has its own heating element; the system would also require a cooling source for the absorption of hydrogen into the metal hydride, and this may be provided via the working fluid and a cooling system such as a radiator, refrigeration system, or other heat exchanger or cooling device.

7. The thermal systems as described in claim 6 may be used in conjunction with any hydrogen source (including compressed hydrogen tanks) or hydrogen production system.

8. The single stage metal hydride compression system final compression ratios may range between 3 and 20.

9. The metal hydride compression system as described in claim 8 may be comprised of sub-stages or stages with multiple hydrogen reactors; the multiple reactors within each compression stage would be arranged such that they absorb hydrogen from the same source and supply the hydrogen to the same destination upon desorption. The configuration of multiple reactors within the same compression stage is somewhat similar to the configuration of resistors in parallel within an electrical circuit.

10. The metal hydride compression system will be in line with a hydrogen storage reservoir which will be sized according to the needs of the system.

11. The compression system and the hydrogen storage units mentioned in claim 9 will remain on board the consumption unit (housed within the same structure as the engine or remaining on the vehicle with the engine).

12. The compression and storage system in claims 8 and 9 may or may not always be connected to the hydrogen source during operation.

13. The configurations as mentioned in claims 8 through 12 may be used together or independently; if the consumption unit requires multiple hydrogen sources, then the unit may be composed of both on board and off board hydrogen sources that either remain in line with the hydrogen compression and storage system or are detachable.

14. The supply of hydrogen will be governed (either electrically or mechanically) such that the hydrogen will only be supplied to the compressor and storage mediums while the unit is in operation or if the unit needs to discharge the hydrogen for safety purposes.

15. The utilization of pressure regulation and mixing chamber sizing in order to control the amount of hydrogen released into final combustion chamber.

16. The said invention utilizes a simple configuration of a mixing chamber for hydrogen and oxygen/air which is regulated to maintain a constant pressure for given environmental conditions.

17. The gas pressures will be regulated such that when the combustion chamber valve opens for the hydrogen and oxygen/air gases to flow and fill the combustion chamber, the amount of combustible gases allowed into the final combustion chamber will be approximately or at stoichiometric conditions or at desired A/F (Air to Fuel) ratios.

18. The H₂ delivery unit may use an existing air or gas flow path for the mixing chamber with the addition of a pressure regulator and or nozzle that is adjusted to supply the correct amount of needed hydrogen for the given size of the existing structures.

19. The delivery of hydrogen will be governed (either electrically or mechanically) such that the hydrogen will only be released while the unit is in operation or if the unit needs to discharge the hydrogen for safety purposes.

20. The hydrogen delivery system (HDS) may be composed of some or all, but not limited to the following components:
i. pressurized hydrogen supply
ii. pressure regulator
iii. gas flow check valves
iv. mixing chamber
v. spark arrestor
vi. valves (solenoid, pressure sensitive, manual, mechanical, etc.)
vii. pressure sensors (including pressure transducers)
viii. temperature sensors (including thermocouples, IR devices, etc.)
ix. nozzles
